(19) United States
(12) Patent Application Publication
(10) Pub. No.: US 2014/0001175 A1
(43) Pub. Date: Jan. 2, 2014

(54) Electromagnetic Frying and Broiling device

(71) Applicant: SEKOND CREATIVE DESIGN CO., LTD., Tainan City (TW)

(72) Inventors: Yuan-Song Tsai, Tainan City (TW); Sheng-chi Lin, Tainan City (TW)

(73) Assignee: Sekond Creative Design Co., Ltd., Tainan City (TW)

(21) Appl. No.: 13/836,323

(22) Filed: Mar. 15, 2013

(30) Foreign Application Priority Data
Jun. 29, 2012 (TW) 101212540

(51) Int. Cl. H05B 6/12

(52) U.S. Cl. CPC H05B 6/12
USPC 219/647

(57) ABSTRACT

An electromagnetic frying and broiling device of the present invention includes an induction cooker and a container for containing food. The container is placed on an upper disk of the induction cooker. The induction cooker includes a heating coil for heating the container. The container includes a bottom plate and a side wall extending upwardly from a circumference of the bottom plate. A plurality of positioning plates extends downwardly from a lower end of the side wall of the container. After the container is placed on the induction cooker, the bottom plate of the container is kept a distance away from the upper disk, and the positioning plates are fastened on an outer periphery of the upper disk so that the container is positioned on the induction cooker.

### BACKGROUND OF THE INVENTION

1. Field of the Invention

The present invention relates to a flying and broiling device and, more particularly, to an electromagnetic frying and broiling device using an induction cooker as a heating source.

2. Description of the Related Art

Barbecue is a popular activity in household, and frying and broiling devices are essential in such activity. Conventional frying and broiling devices usually include a furnace body. Fuel material, such as charcoal, is placed inside the furnace body. A mesh rack or metal stick for piercing food is placed on a top of the furnace body. Food such as sliced meat, corn, sausage, mushroom, etc., is placed on the mesh rack, and flame produced by burning the fuel material is used for heating up and roasting the food. However, the heating by flame is usually uneven which will cause the food to be easily scorched partially.

Induction or electromagnetic cooker used for heating food has the advantages of speedy and even heating. However, conventional combinational structure of induction cooker and pot or broiling tray is not suitable for using in frying or broiling food. Therefore, a frying and broiling device using an induction cooker as a heating source is highly demanded for frying and broiling food for household.

### BRIEF SUMMARY OF THE INVENTION

Thus, an objective of the present invention is to provide an electromagnetic frying and broiling device. The frying and broiling device uses an induction cooker as a heating source for frying and broiling food. The electromagnetic frying and broiling device has the advantages of speedy and even heating and, therefore, is another option for users for using as a frying and broiling device.

To achieve this and other objectives, an electromagnetic frying and broiling device of the present invention includes an induction cooker and a container. The induction cooker includes a bottom base and an upper disk engaged on a top portion of the bottom base. The container is detachably placed on the upper disk of the induction cooker. The container includes a bottom plate and a side wall extending upwardly from a circumference of the bottom plate. A plurality of supporting poles is disposed on a lower surface of the bottom plate of the container, and a plurality of positioning plates extends downwardly from a lower end of the side wall of the container. When the container is placed on the induction cooker, the positioning plates are engaged on an outer periphery of the upper disk, and the bottom plate of the container is spaced from the upper disk of the induction cooker, forming a spacing between the bottom plate and the upper disk.

In a preferred form, the container is made of metal, such as cast iron, iron or steel, which is magnetic permeable.

In a preferred form, the upper disk includes an upper surface and an outer periphery, and the outer periphery is protruded outside of the top portion of the bottom base and forms a flange.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is perspective view of an electromagnetic frying and broiling device according to a first embodiment of the present invention.

FIG. 2 is an exploded, perspective view of the electromagnetic frying and broiling device of FIG. 1.

FIG. 3 is a cross-sectional view of the electromagnetic frying and broiling device of FIG. 1.

FIG. 4 is another exploded, perspective view of the electromagnetic frying and broiling device of FIG. 1.

FIG. 5 is perspective view of an electromagnetic frying and broiling device according to a second embodiment of the present invention.

FIG. 6 is cross-sectional view of the electromagnetic frying and broiling device of FIG. 5.

### DETAILED DESCRIPTION OF THE INVENTION

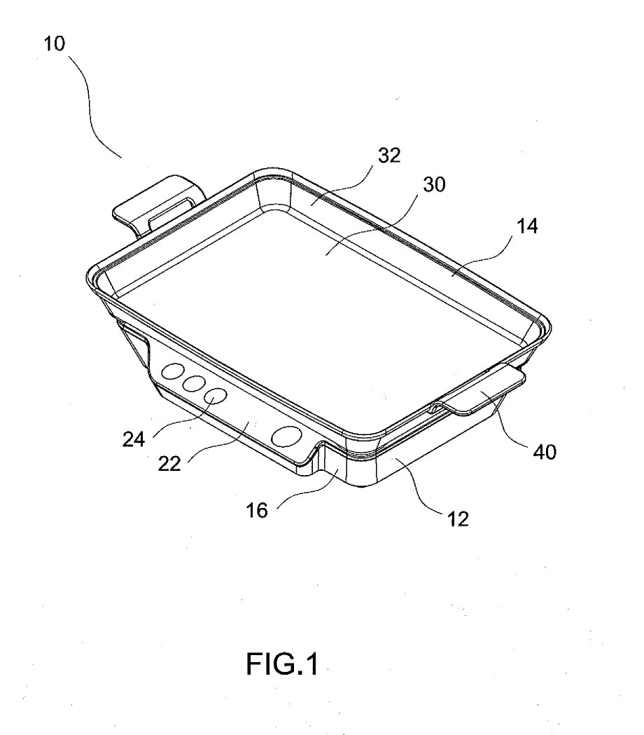

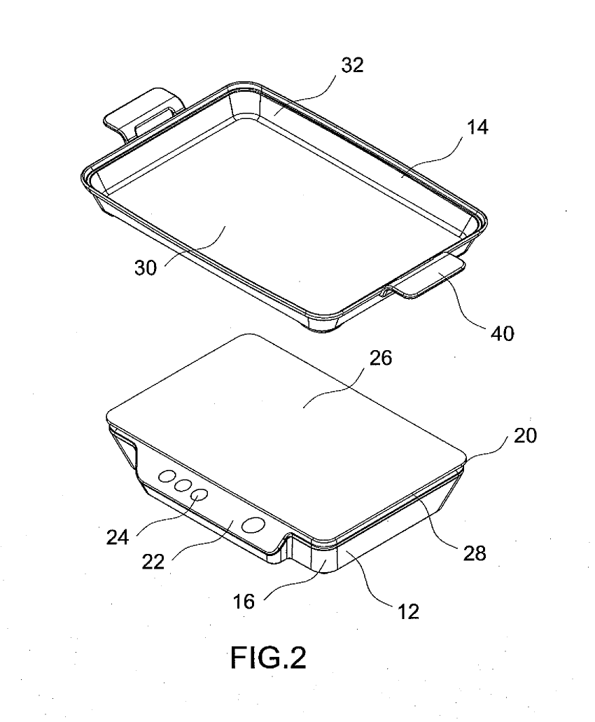

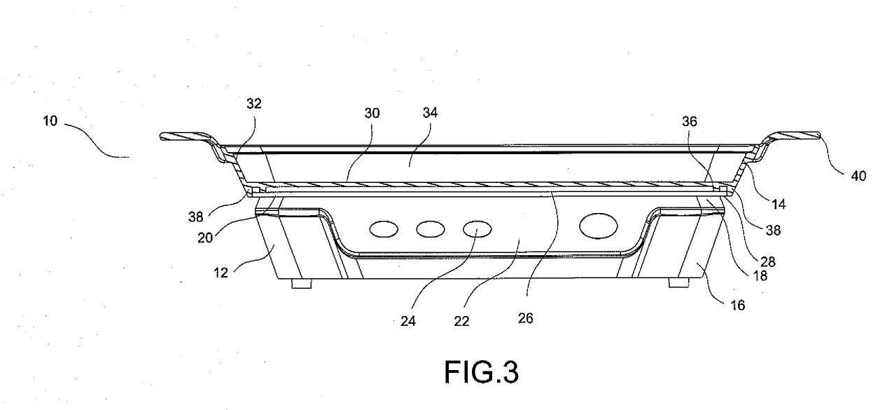

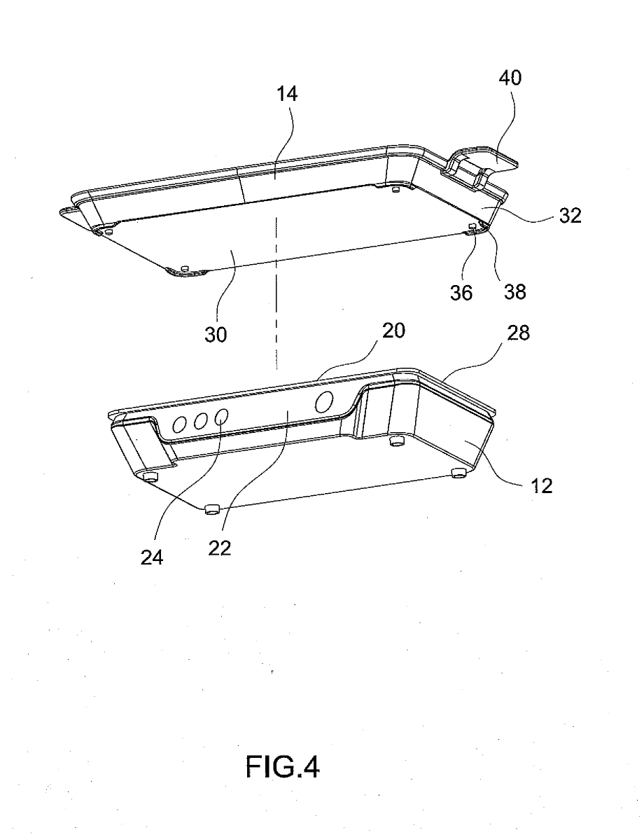

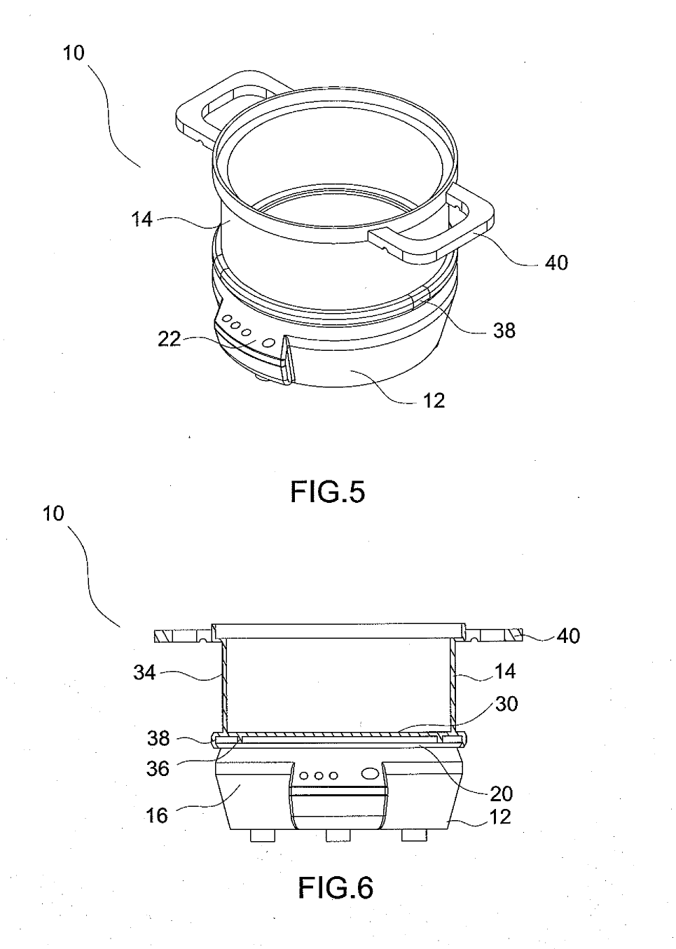

FIGS. 1 through 4 illustrate an electromagnetic frying and broiling device 10 according to an embodiment of the present invention. The electromagnetic frying and broiling device 10 includes an induction cooker 12 and a container 14 for containing food. In this embodiment, the container 14 is a tray with a rectangular section. In another embodiment (as shown in FIGS. 5 and 6), the container 14 is a pot with a circular section. The induction cooker 12 includes a bottom base 16 and an upper disk 20 coupled on a top portion 18 of the bottom base 16. A detecting device and a heating coil (not shown in the drawings) are disposed inside the induction cooker 12. A control panel 22 is disposed on a front side of the bottom base 16, and a plurality of control buttons 24 is disposed on the control panel 22 for operating the induction cooker 12. In this embodiment, the upper disk 20 is made of a ceramic crystal panel with a rectangular section. In the embodiment shown in FIG. 5, the upper disk 20 has a circular section. The upper disk 20 includes an upper surface 26 and an outer periphery 28. The outer periphery 28 is transversely protruded outside of the top portion 18 of the bottom base 16, so that the outer periphery 28 of the upper disk 20 forms a flange.

The container 14 is made of metal, such as cast iron, iron, or steel, which is magnetic permeable. The container 14 is detachably placed on the upper disk 20 of the induction cooker 12 for cooking food. The container 14 includes a bottom plate 30 and a side wall 32 extending upwardly from a circumference of the bottom plate 30. An accommodating chamber 34 is defined between the bottom plate 30 and the side wall 32 for containing food. A plurality of supporting poles 36 is disposed on a lower surface of the bottom plate 30 of the container 14. In this embodiment, the supporting poles 36 are respectively disposed near corners on the lower surface of the bottom plate 30 of the container 14. After the container 14 is placed on the induction cooker 12, the bottom plate 30 of the container 14 is spaced from the upper disk 20 of the induction cooker 12, forming a spacing between the bottom plate 30 of the container 14 and the upper disk 20 of the induction cooker 12. The spacing is preferably 0.3 to 5 mm (i.e.

the height of the supporting poles 36 is 0.3 to 5 mm). Thereby, the detecting device inside the induction cooker 12 can detect the container 14 in order to control the start of the heating coil inside the induction cooker 12. Further, a space formed by the spacing can provide a heat dissipation effect. In a feasible embodiment, the height of the supporting poles 36 is adjustable so that the spacing can be changed. Furthermore, a plurality of positioning plates 38 extends downwardly from a lower end of the side wall 32 of the container 14. In this embodiment, the positioning plates 38 are respectively disposed near corners on the lower end of the side wall 32 of the container 14. When the container 14 is placed on the induction cooker 12, the positioning plates 38 are engaged on the outer periphery 28 of the upper disk 20, so that the container 14 is coupled and positioned with the upper disk 20 of the induction cooker 12. Further, handles 40 for holding onto are disposed on two sides of the side wall 32 of the container 14.

When using the electromagnetic frying and broiling device 10, food is placed in the container 14, and the bottom plate 30 of the container 14 is placed on the upper disk 20 of the induction cooker 12. After the power of the induction cooker 12 is turned on, the detecting device inside the induction cooker 12 detects the container 14 and conducts the heating coil inside the induction cooker 12 to produce an eddy current to heat up the container 14, and heating effect is obtained for frying and broiling the food in the container 14. The electromagnetic frying and broiling device 10 of the present invention not only can use the induction cooker 12 as the heating source for frying and broiling food, the container 14 can also be positioned on the upper disk 20 of the induction cooker 12 so that the container 14 will remain unmoved on the induction cooker 12. Furthermore, a predetermined spacing is kept between the container 14 and the upper disk 20 of the induction cooker 12 for providing excellent heat dissipation.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. An electromagnetic frying and broiling device, comprising:
an induction cooker including a bottom base and an upper disk engaged on a top portion of the bottom base, with the upper disk including an outer periphery; and
a container detachably placed on the upper disk of the induction cooker, with the container including a bottom plate and a side wall extending upwardly from a circumference of the bottom plate, with the container further including a plurality of supporting poles disposed on a lower surface of the bottom plate of the container, with the container further including a plurality of positioning plates extending downwardly from a lower end of the side wall of the container,
wherein when the container is placed on the induction cooker, the positioning plates is engaged on the outer periphery of the upper disk, and the bottom plate of the container is spaced from the upper disk of the induction cooker, forming a spacing between the bottom plate of the container and the upper disk of the induction cooker.

2. The electromagnetic frying and broiling device according to claim 1, with the outer periphery of the upper disk protruded outside of the top portion of the bottom base to form a flange.

3. The electromagnetic frying and broiling device according to claim 2, with the supporting poles respectively disposed near corners on the lower surface of the bottom plate of the container, with each of the supporting poles having a height of 0.3 to 5 mm, with the positioning plates respectively disposed near corners on the lower end of the side wall of the container.
